(19) United States
(12) Patent Application Publication
(10) Pub. No.: US 2025/0073973 A1
(43) Pub. Date: Mar. 6, 2025

(54) Waterproof and Drainage Integrated Board Forming Machine, Waterproof and Drainage Integrated Board and Forming Process Thereof

(71) Applicant: Zhejiang Junheng Machinery Manufacturing CO., LTD., Shaoxing, Zhejiang Province (CN)

(72) Inventor: Qin Zhou, Shaoxing, Jiangsu Province (CN)

(21) Appl. No.: 18/290,136

(22) PCT Filed: May 13, 2022
(86) PCT No.: PCT/CN2022/092685

§ 371 Date: Nov. 9, 2023

(30) Foreign Application Priority Data
May 17, 2021 (CN) 202110532389.4

(51) Int. Cl. B29C 48/00; B29C 48/08; B29C 48/28; B29C 48/30; B29C 48/35; B29C 48/885; B29C 48/91; B29C 48/92; B29L 7/00; B29L 31/10; B32B 3/30; E02D 31/02

(52) U.S. Cl. CPC B29C 48/002; B29C 48/0021; B29C 48/08; B29C 48/28; B29C 48/302; B29C 48/35; B29C 48/885; B29C 48/91; B29C 48/92; B32B 3/30; E02D 31/025; B29C 2948/92647; B29C 2948/92857; B29C 2948/92923; B29K 2995/0069; B29L 2007/002; B29L 2031/10; B32B 2307/7265; B32B 2607/00

(57) ABSTRACT

Disclosed are a waterproof and drainage integrated board, a forming machine and a forming process. A rack is provided with a first concave roller, a convex roller, a second concave roller and a mirror roller, the convex roller rolls relative to the first concave roller and the second concave roller, and the mirror roller rolls relative to the second concave roller. A drainage layer substrate of the present invention is extruded from a first extruder head, immediately follows the second concave roller after shaping to a bottom part, and is directly fused with a waterproof layer just extruded from a second extruder head and formed. By adjusting a gap between the second concave roller and the mirror roller to apply a certain pressure for pressing and calendering, the drainage layer and the waterproof layer are integrated. A hollow boss has good strength, and a bottom surface opening thereof is also closed by the waterproof layer. Even if the boss breaks and leaks, the waterproof layer is present to prevent leakage. In addition, the substrate and the fused waterproof layer has double layer thickness, which further improves the strength and waterproofness thereof.

### TECHNICAL FIELD

This invention relates to the technical field of building engineering component forming machine, particularly a waterproof and drainage integrated board forming machine, waterproof and drainage integrated board and forming process thereof.

### BACKGROUND ART

Drainage facilities are widely applied in construction, transportation, gardening and municipal works, among which the plastic drainage boards are the most popular. The plastic drainage board consists of a boss made of plastic substrate treated with plastic blister technology, which is laid on the ground, soil or rock layers and other substrates to prevent water infiltration with the space between the adjacent bosses serving as a drainage channel. A Drainage Board Forming Machine disclosed by this inventor, Chinese utility patent No. 2011103758741, can produce the common single-layer drainage board. However, the drainage board formed by such machine may break because of the forming thickness (e.g. thinner board to save the material), the material (e.g. use of mixed material to reduce the cost), the working environment (e.g. applications in sandstone areas where the plastic layer is easy to be damaged), the aging of the plastic and other factors, particularly at the boss that is projected and bears the load. Therefore, the boss is more likely to be damaged and leaks occur consequently. During the actual application, additional bituminous waterproof layer is required on the soil and other bases for the waterproof effect.

A Self-adhesive Waterproofing Integrated Drainage Board, Chinese utility US2019213530377 attempts to combine the waterproof asphalt roll with the bottom of the drainage board as a whole by fusing. When the drainage board is laid, a blowtorch is used to melt the waterproof roll fused to bottom of the drainage board at a controlled temperature that is sufficient to melt the surface of the waterproof roll but does not make the melt liquid flow. Lay and extend forward the draingage board while heating it. Actually, this method is just a simple combination of drainage board and asphalt layer, which comes with a heavy workload, difficulty in controlling the heating effect of the blowtorch and loss of bearing capacity as a result of softening and deforming of boss on the drainage board and even leads to the burn-through of the drainage board. So, this method still has certain defects.

### SUMMARY OF THE INVENTION

Aiming at these drawbacks of the existing drainage board forming technologies, the applicant provides a reasonably-structured waterproof and drainage integrated board forming machine, waterproof and drainage integrated board and forming process thereof, which have good drainage and waterproof performance and reduce the investment of the production line and the inventory cost.

Technical solutions using the present invention are as follows:

A waterproof and drainage integrated board forming machine, in which a rack is provided with a first concave roller, a convex roller, a second concave roller and a mirror roller, the convex roller rolls relative to the first concave roller and the second concave roller, and the mirror roller rolls relative to the second concave roller;

A first concave roller with a number of first concave cavities provided on the roller surface, a second concave roller with a number of second concave cavities provided on the roller surface, the roller surface of the convex roller provided with a number of convex grains to match with the first concave cavities and the second concave cavities respectively; the smooth surface of the mirror roller.

Further improvements of these technical solutions:

The convex roller meets the first concave roller on one side of the first extruder head; the convex roller, the second concave roller and the mirror roller are arranged in sequence, and the second concave roller meets the mirror roller on one side of the second extruder head.

The line of center between the convex roller and the first concave roller is orthogonal to that of the convex roller and the second concave roller, and the convex roller, the second concave roller and the mirror roller are arranged in the described order.

The center axes of the first concave roller, the convex roller, the second concave roller and the mirror roller are in a horizontal plane; or the center axes of the second concave roller and the mirror roller are in a horizontal plane, and the angle β between the line of center between the first concave roller and the convex roller and that between the second concave roller and the mirror roller is greater than 90° and less than 180°.

The centering angle α of the wrapping arc of the substrate around the convex roller is 180° or above, and the length of such arc is πr or more.

The second extruder head directs at the position where the second concave roller meets with the mirror roller; or the second extruder head moves a horizontal distance d away from the meeting position abovementioned and toward the mirror roller.

A heating device is equipped in the second concave roller or mirror roller, which provides the heating temperature from 30° C. to 80° C.

A heating gun is equipped on the outside of the second concave roller and heats the bottom surface of the substrate at a temperature between 200° C. and 400° C.

A roller of hot melt adhesive sheet is equipped on the outside of the junction between the second concave roller and the mirror roller.

A heating plate is equipped on the outside and keeps a certain distance from the second concave roller. The heating area partially covers the drainage layer winded during operation. The said heating plate is curved and is arranged outside of the second concave roller and near the top of the convex roller.

Sliding blocks are equipped on the supports at both ends of the first concave roller, the convex roller and the mirror roller. The rack is correspondingly provided with slide rails, and the sliding blocks are arranged on the second slide rail in the sliding manner. The first concave roller, the convex roller and the mirror roller are driven to slide by a linear drive mechanism for adjustment of the gap between the two rollers. The opening diameters of the first concave cavities and the second concave cavities are matched and larger than the outer diameter of the convex grains. The radial spacing between the surface of convex grains and the inner surface of the first concave cavities/second concave cavities matches the thickness of the substrate or is larger. The gap between the mirror roller and the second concave roller is smaller than the sum of the thicknesses of the substrate and waterproof layer.

The first concave roller is connected to the motor through a transmission mechanism; the first concave roller, the convex roller, the second concave roller and the mirror roller transmit the torque through gears; the rack is provided with a guide roller that is connected to the motor through a transmission mechanism.

Some wheels are equipped on both sides of the rack at the bottom oppositely, which are connected to the motor through a transmission mechanism and surrounded by wheel teeth. The rails are arranged on the workshop floor correspondingly, and equipped with wheel teeth. The wheel teeth of wheels match the wheel teeth of rails.

A waterproof and drainage integrated board forming process using the mentioned waterproof and drainage integrated board forming machine, which includes following steps:
I. The first extruder extrudes and forms the flat substrate;
II. The substrate enters between the first concave roller and the convex roller, forming a hollow boss;
III. After the substrate and the boss form a drainage layer, move from the convex roller to the second concave roller;
IV. The second extruder extrudes and forms a flat waterproof layer that enters between the second concave roller and the mirror roller with the drainage layer. The waterproof layer and the substrate bottom of the drainage layer are fused under a pressure, forming a waterproof and drainage integrated board.

Further improvements of these technical solutions:

Heat the substrate bottom before the waterproof layer is fused with the substrate bottom.

A waterproof and drainage integrated board produced by the mentioned waterproof and drainage integrated board forming machine. The drainage layer consists of a substrate and a hollow boss. The waterproof layer is fused with the substrate bottom and seals the opening at the bottom of boss. Integrate the drainage layer and the waterproof layer during the extrusion.

Further improvements of these technical solutions:

There is a “crater-like” press-in part in the boss, which is high on the periphery and low in the center. There is a fused flat layer of the drainage layer and the waterproof layer between bosses.

The maximum thickness of press-in part Tmax is larger than the thickness of fused flat layer t.

The minimum thickness of press-in part Tmin is equal to or larger than the thickness of waterproof layer t₂.

The average thickness T of press-in part is larger than the thickness of fused flat layer t.

The waterproof layer is bonded with the drainage layer through the hot melt adhesive layer.

This invention provides the following advantageous effects:

A drainage layer substrate of the present invention is extruded from a first extruder head, immediately follows the second concave roller after shaping to a bottom part, and is directly fused with a waterproof layer just extruded from a second extruder head and formed. By adjusting a gap between the second concave roller and the mirror roller to apply a certain pressure for pressing and calendering, the drainage layer and the waterproof layer are integrated. A hollow boss has good strength, and a bottom surface opening thereof is also closed by the waterproof layer. Even if the boss breaks and leaks, the waterproof layer is present to prevent leakage. In addition, the substrate and the fused waterproof layer has double layer thickness, which further improves the strength and waterproofness thereof, which further improves the strength and waterproof capacity. The waterproof and drainage integrated board of the present invention can be laid without the need for asphalt or waterproof roll. It has been proven that the waterproof layer of such board provides the waterproof effect equivalent to the asphalt layer. So, the board can be laid directly on the substrate.

Before being fused with the waterproof layer, the substrate of the present invention rotates with the second concave roller and is cooled for a period. The heating plate just heats the substrate bottom while the boss of the substrate is left in the second concave cavity for cooling, which balances the heating and heat preservation of the substrate bottom and cooling of the boss. Therefore, the bottom can be fused with the waterproof layer successfully at a higher temperature, and the boss has sufficient time and space for cooling to prevent deformation and ensure its forming stability and strength.

The waterproof layer of the present invention is directly extruded, i.e. fused. So, there is no need for separate production and winding, which reduces the equipment cost and space demand and thus saves the investment of the production line. On the other hand, it is unnecessary to store the waterproof rolls and reserve a storage space, cutting the inventory cost.

The first concave roller, the convex roller and the mirror roller of the present invention adjust the radial distance through the sliding movement of the support, so as to match with the substrates and waterproof layers of different thickness, and flexibly apply to the drainage boards of various specifications, expanding the scope of application. Adjusting the radial distance can also adjust the compression force between the substrate and the waterproof layer to improve the fusing effect and the reliability of the drainage board. The adjustable support also makes the distance between the forming machine and the extruder adjustable, which guarantees the product quality and facilitates the equipment maintenance.

### DESCRIPTION OF ATTACHED DRAWINGS

FIG. 1 is a 3D drawing of the first embodiment of the present invention.

FIG. 2 is a detailed drawing of part A in FIG. 1.

FIG. 3 is a front view of the first embodiment of the present invention.

FIG. 4 is a section view B-B in FIG. 3, in which the arrows indicate the direction of rotation of rollers.

FIG. 5 is a detailed drawing of part C in FIG. 4.

FIG. 6 is a detailed drawing of part C in FIG. 4.

FIG. 7 is a detailed drawing of part E in FIG. 4.

FIG. 8 is a left view of the FIG. 3.

FIG. 9 is a schematic drawing of the second embodiment of the present invention.

FIG. 10 is a schematic drawing of the third embodiment of the present invention.

FIG. 11 is a schematic drawing of the waterproof and drainage integrated board.

FIG. 12 is a detailed drawing of part F in FIG. 11.

FIG. 13 is a schematic drawing of another embodiment of the waterproof and drainage integrated board.

In these figures, there is a rack 1, a first concave roller 2, first concave cavities 21, a convex roller 3, a convex grain 31, a second concave roller 4, second concave cavities 41, a mirror roller 5, a guide roller 6, a heating plate 7, rails 8, wheel teeth 81, wheels 9, wheel teeth 91, a driving wheel 10, a primary driven wheel 11, a secondary driven wheel 12, a tertiary driven wheel 13, a first support 14, first sliding blocks 15, first slide rails 16, a second support 17, second sliding blocks 18, second slide rails 19, a third support 20, third sliding blocks 26, third slide rails 22, a fourth support 23, a first extruder head 24, a second extruder head 25, a heating gun 27, a membrane winding roller 28, a substrate 100, bosses 101, an entry point 102, a leaving point 103, a wrapping arc 104, a waterproof layer 200, a press-in part 201, a hot melt adhesive membrane 300, and a fused flat layer 400.

### EMBODIMENT

The specific embodiments of the present invention are described by means of the attached drawings below.

### The First Embodiment

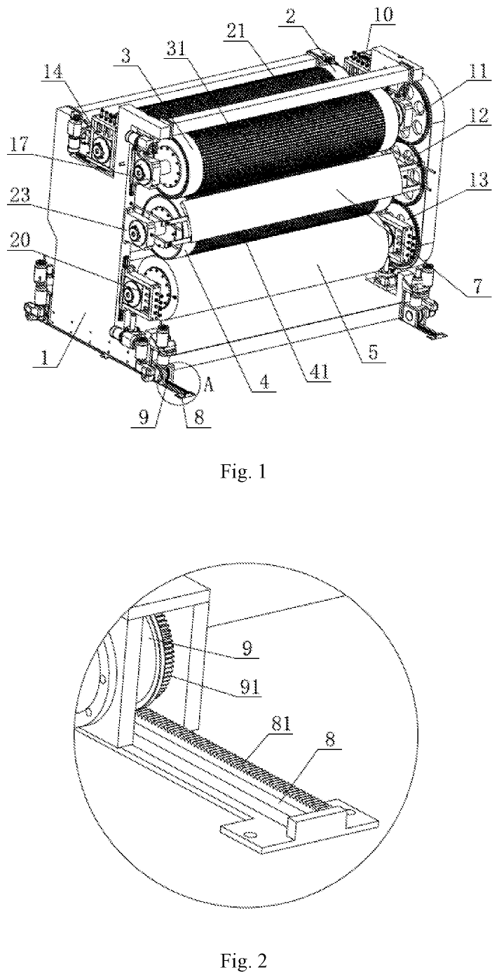

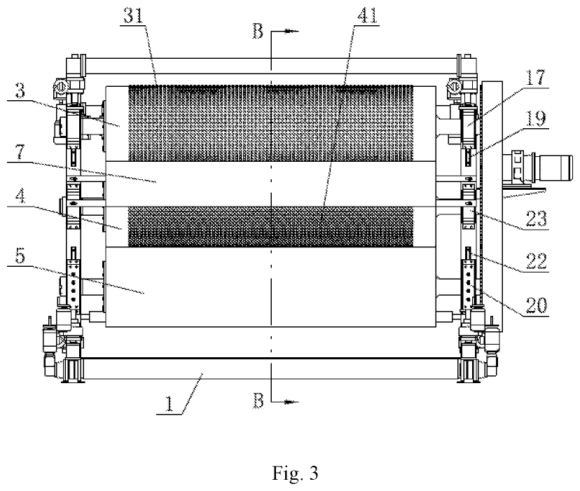

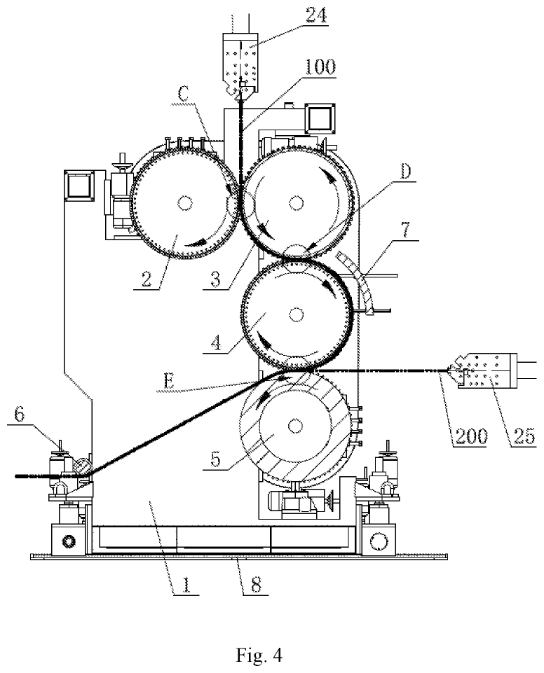

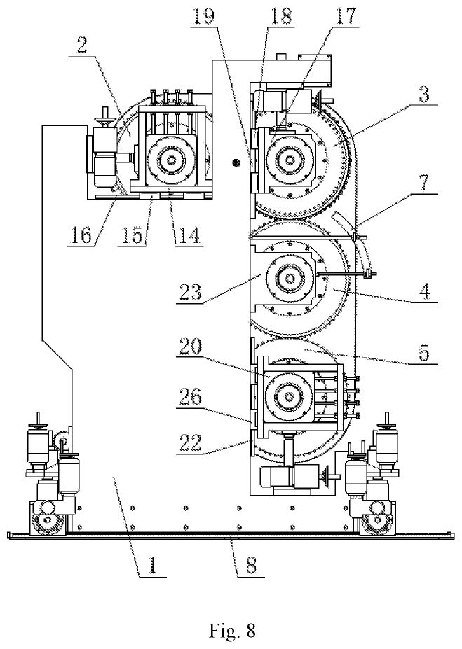

As illustrated in FIG. 1, FIG. 3, FIG. 4 and FIG. 8, the rack 1 of the present invention is provided with vertical support plates at opposite sides, and a first concave roller 2, a convex roller 3, a second concave roller 4 and a mirror roller (also called smooth roller) are arranged horizontally between such support plates. The first concave roller 2 is located behind the convex roller 3 with the center axis of both rollers in a horizontal plane. The second concave roller 4 and the mirror roller 5 are arranged right below the convex roller 3 in order, with the center axis of three rollers in a vertical plane. The line of center between the convex roller 3 and the first concave roller 2 is orthogonal to that among the convex roller 3, the second concave roller 4 and the mirror roller 5. There are a number of first concave cavities 21 on the circumference of the first concave roller 2, a number of second concave cavities 41 on the circumference of the second concave roller 4, and a number of convex grains 31 on the circumference of the convex roller 3. Convex grains 31 match with the first concave cavities 31 and the second concave cavities 41 respectively. The radial distance between the top of convex grains 31 and the bottom of the first concave cavities 21 or the second concave cavities 41 is equal to or greater than the thickness of the substrate 100, ensuring the height of the boss 101 punched by convex grains 31 on the substrate 100 in compliance with specifications. The opening diameter of the first concave cavities 21 and the second concave cavities 41 match and are larger than the outer diameter of convex grains 31. The radial distance between the outside of convex grains 31 and the inside of the first concave cavities 21 or the second concave cavities 41 matches the thickness of the substrate 100 or is larger, which facilities to press the substrate 100 by convex grains 31 into the first concave cavities 21 or the second concave cavities 41 and minimize the pressing resistance for easy forming of the boss 101. The circumference of the mirror roller 5 is smooth. The gap between the mirror roller 5 and the second concave roller 4 is smaller the sum of thickness of the substrate 100 and the waterproof layer 200, ensuring the successful integration of the substrate 100 and the waterproof layer 200.

As illustrated in FIG. 1, the first concave roller 2 is connected to the motor through the transmission mechanism. The first concave roller 2 is equipped with a set of driving wheels 10, the convex roller 3 is equipped with a set of primary driven wheels 11, the second concave roller 4 is equipped with a set of secondary driven wheels 12 and the mirror roller 5 is equipped with a set of tertiary driven wheels 13, in which the driven wheels 10, the primary driven wheels 11, the secondary driven wheels 12 and the tertiary driven wheels 13 are toothed gear, transferring the torque through these wheels respectively. In practice, the motor drives the first concave roller 2 to rotate through the transmission mechanism, and then the convex roller 3, the second concave roller 4 and the mirror roller 5 to rotate through the gear transmission in turn. As illustrated in FIG. 4, the first concave roller 2, the convex roller 3 and the second concave roller 4 rotate relatively to the convex roller 3, the second concave roller 4 and the mirror rollers 5 respectively.

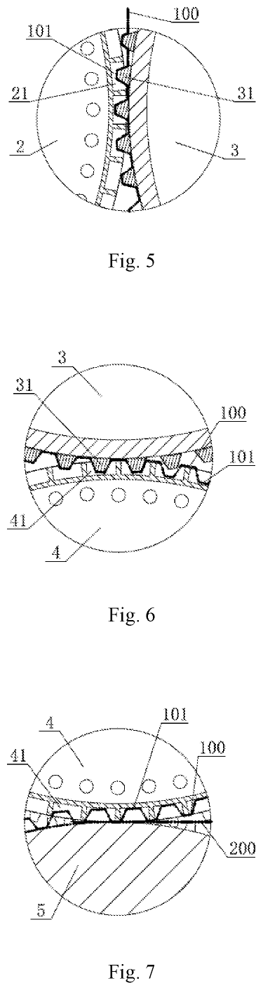

As illustrated in FIGS. 4 to 7, a first extruder head 24 of a first extruding machine (not structured according to this patent) is provided above the position where a first concave roller 2 and a convex roller 3 meet. The first extruding machine extrudes a substrate 100 through the first extruder head 24. The substrate 100 enters into the position where the first concave roller 2 and the convex roller 3 meet in a continuous manner. The convex grains 31 on the convex roller 3 press the some parts of the substrate 100 into the first concave cavities 21 of the first concave roller 2 while the vacuum adsorption mechanism on the convex roller 3 works to plasticize, forming a number of open-end hollow bosses 101 arranged in order on the substrate 100. By this way a drainage board is formed as whole, comprising of the substrate 100 and the boss 101 and defined in the present patent. The convex roller 3 rotates to deliver the formed drainage layer to the position where the second concave roller 4 is met. To match convex grains 31 with the second concave cavity 41, the boss 101 of the drainage layer is transferred into the second concave cavity 41 and held in the second concave cavity 41 to rotate with the second concave roller 4 to the position where the mirror roller 5 is met. The rotation of the second concave roller 4 gives time to cool down the boss 101, which is helpful for better stability and strength of the formed boss 101 and prevents the boss 101 from deformation. A second extruder head 25 of a second extruding machine (not structured according to this patent) is provided on the side where a second concave roller 4 and a mirror roller 5 meet. The second extruding machine extrudes a waterproof layer 200 through the second extruder head 25. The waterproof layer 200 enters into the position where the second concave roller 4 and the mirror roller 5 meet in a continuous manner and gets fused with the substrate 100 of the waterproof layer transferred with the second concave roller 4 on the bottom. The second concave roller 4 rotates to the outer side of the drainage layer. A curved heating plate 7 is provided at a certain distance from the second concave roller 4. The heating plate 7 is equipped on the outer side of the second concave roller 4 and near the top of the convex roller 3. The heating surface of the heating plate 7 partially covers the drainage layer that is wound during operation. The heating plate 7 heats or preserves the heat on the bottom of the substrate 100 of the drainage layer, which is helpful for fusing the substrate 100 with the waterproof layer 200 smoothly. Meanwhile, the boss 101 of the drainage layer is held in the second concave cavity 41. The second concave cavity 41 can protect the boss 101, preventing the boss 101 from further heating due to the operation of the heating plate 7, improving the stability of the formed boss 101 of the drainage layer and protecting the boss 101 against deformation.

As illustrated in FIGS. 1 and 8, both ends of the first concave roller 2 are provided with a first support 14. The first support 14 is coupled with a motor. The bottom of the first support 14 is fixed with a first sliding block 15. A first slide rail 16 is provided on the rack 1 correspondingly so that the first sliding block 15 sits on the first slide rail 16 in a sliding manner. The first support 14 is driven by the motor to slide backward and forward along the first slide rail 16, adjusting the radial distance between the first concave roller 2 and the convex roller 3 in the radial direction. The both ends of the convex roller 3 are provided with a second support 17. The second support 17 is coupled with a motor. A second sliding block 18 is fixed on the side of the second support 17. A second slide rail 19 is provided on the rack 1 correspondingly so that the second sliding block 18 sits on the second slide rail 19 in a sliding manner. The second support 17 is driven by the motor to slide up and down along the second slide rail 19, adjusting the radial distance between the second concave roller 4 and the convex roller 3 in the radial direction. The both ends of the mirror roller 5 are provided with a third support 20. The third support 20 is coupled with a motor. A third sliding block 26 is fixed on the side of the third support 17. A third slide rail 22 is provided on the rack 1 correspondingly so that the third sliding block 26 sits on the third slide rail 22 in a sliding manner. The third support 20 is driven by the motor to slide up and down along the third slide rail 22, adjusting the radial distance between the second concave roller 4 and the mirror roller 5 in the radial direction. The both ends of the second concave roller 4 are provided with a fourth support 23. The fourth support 23 is fixed on the rack 1 with fasteners. The first concave roller 2, the convex roller 3 and the mirror roller 5 of this embodiment adjust the radial distance through the sliding movement of the supports, so as to match with the substrates and waterproof layers of different thickness, and flexibly apply to the drainage boards of various specifications, expanding the scope of application. Adjusting the radial distance can also adjust the compression force between the substrate 100 and the waterproof layer 200 to improve the fusing effect and the reliability of the drainage board. In other embodiments, the first concave roller 2, the convex roller 3 and the mirror roller 5 are driven to slide by other linear drive mechanism, adjusting the radial distance.

As illustrated in FIG. 4, a guide roller 6 is provided at the rear lower side of the mirror roller 5 on the rack 1. The guide roller 6 is coupled with a motor through a transmission mechanism. In practice, the motor drives the guide roller 6 to rotate through the transmission mechanism, delivering the waterproof and drainage integrated board into the next process.

As illustrated in FIGS. 1 and 2, two rails 8 are laid in parallel on the workshop floor along the delivery direction of the drainage board. A number of teeth 81 are uniformly arranged on the top of the rails 8. Several wheels 9 are provided on both sides of the rack 1 on the bottom, corresponding to the rails 8. The outer periphery of the wheels 9 are made with teeth 91. The teeth 91 of the wheels 9 match with the teeth 81 of the rails 8. The wheels 9 are coupled to a motor by a transmission mechanism. The motor drives the wheels 9 to rotate through the transmission mechanism, enabling the wheels 9 to move on the rails 8 for adjustments to the position of the machine.

During the actual application of this invention, a substrate 100 is extruded by a first extruding machine through a first extruder head 24, plasticized through the first concave roller 2 and the convex roller 3 to form the waterproof layer, rotated with the convex roller 3 to the position where the second concave roller 4 meets, wound around the second concave roller 4 when the convex roller 3 meets with the second concave roller 4, and then rotated with the second concave roller4 to the position where the second concave roller 4 meets with the mirror roller 5. The waterproof layer is extruded by a second extruding machine through a second extruder head 25 and fused on the drainage layer at the position where the second concave roller 4 meets with the mirror roller 5. The integrated drainage board is delivered to the next process by means of the guide roller 6.

### The Second Embodiment

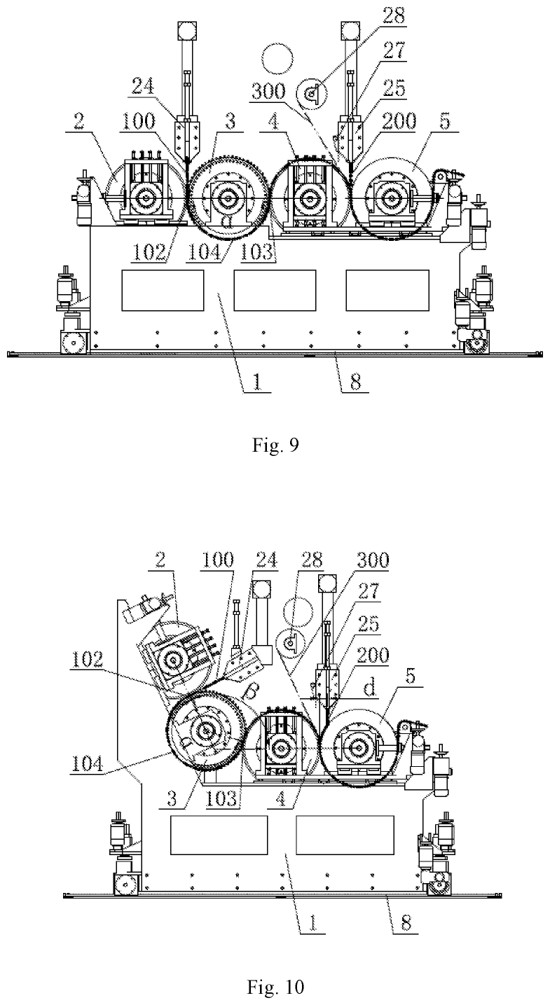

As illustrated in FIG. 9 of this embodiment, a first concave roller 2, a convex roller 2, a second concave roller 4 and a mirror roller 5 are arranged horizontally side by side with the center axis of these four rollers in a horizontal plane and the cross point between any two of these four rollers in a plane.

A first extruder head 24 is located vertically above the position where the first concave roller 2 meets with the convex roller 3, and extrudes the substrate 100 vertically downward toward the position where the first concave roller 2 meets with the convex roller 3. The substrate 100 enters the entry point 102 where the first concave roller 2 meets with the convex roller 3, and a number of open-end hollow bosses 101 are formed and arranged in order on the substrate 100. The arc between the entry point 102 and the leaving point 103 where the convex roller 3 is disengaged from the second concave roller 4 is defined as the wrapping arc around the convex roller 3. The central angle α of the wrapping arc 104 at this time is 180°, and the length L of the wrapping arc 104 is nr (r is the radius of the convex roller 3, and the arc length L is equal to the ½ of circumference of the convex roller 3). Compared to the first embodiment, the wrapping arc 104 of the present embodiment has a larger central angle and a longer arc length. So, the substrate 100 travels a longer stroke and stays on the convex roller 3 for a longer time after being formed. In other words, a longer forming stroke and time are provided to the substrate 100 on the convex roller 3, which is more helpful for forming of the hollow boss 101 on the substrate 100, reducing the shrinkage of the substrate 100 after disengaging from the convex roller 3, and improving the forming stability and strength of the substrate 100.

A second extruder head 25 is located vertically above the position where the second concave roller 4 meets with the mirror roller 5, and extrudes the waterproof layer 200 vertically downward toward the position where the second concave roller 4 meets with the mirror roller 5. The second concave roller 4 is arranged horizontally to the mirror roller 5, facilitating the vertical flow of the waterproof layer 200. The vertical flow of the waterproof layer 200 is more helpful for hot melting with the substrate 100, improving the integration flatness. The second extruder head 25 directs at the position where the second concave roller 4 meets with the mirror roller 5, which is helpful for vertical entry of the waterproof layer 200 into such position and better integration of the substrate 100 with the waterproof layer 200, and improving the bonding strength between the substrate 100 and the waterproof layer 200.

In this embodiment, a heating device is equipped in the second concave roller 4 and the mirror roller 5 respectively, which heats the surface of the second concave roller 4 and the mirror roller 5 and provides the heating temperature from 30° C. to 80° C. Heating the surface of the second concave roller 4 can prevent the boss 101 of the substrate 100 from staying in and blocking the second concave cavity 41 as a result of shrinkage. Heating the surface of the mirror roller 5 is helpful for hot melting of the extruded waterproof layer 200 with the substrate 100, improving the bonding strength and guaranteeing a better integration effect.

To improve the integration effect and fuse the substrate 100 with the waterproof layer 200 better, the second concave roller 4 is equipped with a heating gun on the outer side in this embodiment. The heating gun 27 heats the bottom of the substrate 100 at a controlled temperature between 200° C. and 400° C. The heating temperature of the heating gun is determined by the linear speed of the substrate 100. The heating temperature of the heating gun is low when the linear speed of the substrate 100 is slow. And the heating temperature of the heating gun is high when the linear speed of the substrate 100 is quick. The flow of hot air from the heating gun 27 is controlled in the variable frequency manner.

To further increase the force peel the waterproof layer 200 from the thinner substrate 100, a membrane winding roller 28 is utilized in this embodiment, located at the outer side of the position where the second concave roller 4 meets with the mirror roller 5 to accommodate the hot melt adhesive membrane roll. The hot melt adhesive membrane 300 is released from the hot melt adhesive membrane roll to the position where the second concave roller 4 meets with the mirror roller 5 and the substrate 100 meets with the waterproof layer 200, and then melt between the substrate 100 and the waterproof layer 200 to improve the bonding strength.

### The Third Embodiment

As illustrated in FIG. 10, the second concave roller 4 and the mirror roller 5 are arranged horizontally while the first concave roller 2 and the convex roller 3 incline upward to a certain extent, which is the difference between this embodiment and the second embodiment. In other words, the angle β between the line of centers between the first concave roller 2 and the convex roller 3 and that between the second concave roller 4 and the mirror roller 5 is larger than 90° yet smaller than 180°. At this time, the central angle α of the wrapping arc 104 of the substrate 100 on the convex roller 3 is larger than 180° yet smaller than 270° and the arc length L is longer than r yet shorter than 1.5πr, further increasing the central angle and the arc length of the wrapping arc 104. So, it helps the hollow boss 101 stay on the convex grains 31 of the substrate 100 for a longer time, preventing the shrinkage as a result of earlier disengagement and improving the forming stability and strength of the substrate 100.

The second extruder head 25 is moved from the position where the second concave roller 4 meets with the mirror roller 25 to the mirror roller 5 at a distance d between 50 mm and 200 mm. Since the second extruder head 25 is closer to the mirror roller 5, the waterproof layer 200 extruded from the second extruder head 25 flows to the mirror roller 5 first and gets crystallized on the surface of the mirror roller 5. Then it is rotated with the mirror roller 5 and enters the position where the second concave roller 4 meets with the mirror roller 25 for integration. As the waterproof layer 200 gets crystallized preliminarily on the mirror roller 5 for a period and then melts with the substrate 100, the flatness is improved.

Embodiment 1 of the waterproof and drainage board:

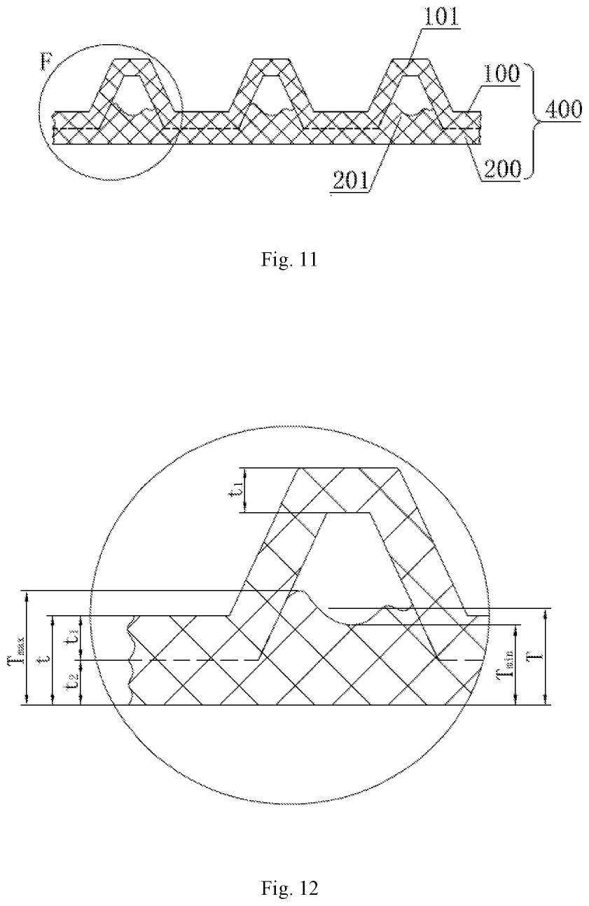

As illustrated in FIGS. 11 and 12, the waterproof and drainage integrated board formed by the mentioned machine compromises of the substrate 100 and the drainage layer and waterproof layer 200 fused on the boss 101. The top of the waterproof layer 200 is melt with the bottom of the substrate 100, sealing the open end of the boss 101. After the substrate 100 is fused with the waterproof layer 200, a fused flat layer 400 is formed between bosses 101. The thickness of the fused flat layer 400 is the sum of the thickness of substrate 100 t₁ and the thickness of the waterproof layer 200 t₂. There is an extrusion force between rollers to integrate the substrate 100 and the waterproof layer 200. Since the boss 101 is hollow and open at the end, the surface of the waterproof layer 200, softened at a higher temperature, is pressed into the boss 101 under such extrusion force. A press-in part 201 is formed at the mouth of the boss 101 after the waterproof layer 200 is cooled. The press-in part 201 looks like a crater, which is high on the periphery and low in the center. As illustrated in FIG. 12, cut the waterproof and drainage integrated board horizontally at different positions, and measure the thickness of the fused flat layer 400 t, the thickness of the substrate 100 t₁, and the thickness of random sampling points of the press-in part 201 Tn (five sampling points in this embodiment) respectively. Based on the measurement results, work out the thickness of waterproof layer t₂ and the average thickness T of the press-in part 201. A waterproof and drainage integrated board is sampled in this embodiment. Measured results: thickness of the fused flat layer 400 t=2.2 mm, thickness of the substrate 100 t₁=1.0 mm, thickness of five points of the press-in part 201 Tn=3.6 mm, 4.2 mm, 2.5 mm, 3.0 mm and 4.4 mm respectively. Calculated thickness of waterproof layer t₂=2.2−1.0=1.2 mm, calculated average thickness of the press-in part 201 T=(3.6+4.2+2.5+3.0+4.4)/5-3.54 mm. Both measurements and the calculation results show that the maximum thickness Tmax of the press-in part 201 is larger than the thickness t of the fused flat layer 400 and the minimum thickness Tmin of the press-in part 201 is larger than the thickness t₂ of the waterproof layer 200. If the inner diameter of the boss 101 is small, the extrusion height of the press-in part 201 in the boss 101 is greater and the average thickness of the press-in part 201 is even larger than the thickness of the fused flat layer 400 t. The press-in part 201 in the boss 101 of the waterproof layer 200 seals the bottom of the boss 101, improving the life and reliability of the waterproof layer. Furthermore, the press-in part 201 supports the corners of the open end of the boss 101 strongly because its outside is closely against the inside of the boss 101 when the press-in part 201 is pressed into the boss 101. It provides a better support to the boss 101, reinforcing the boss 101 and preventing the boss 101 from deformation for an optimized pressure resistance, a longer life and a higher reliability of the waterproof board.

Embodiment 2 of the waterproof and drainage board:

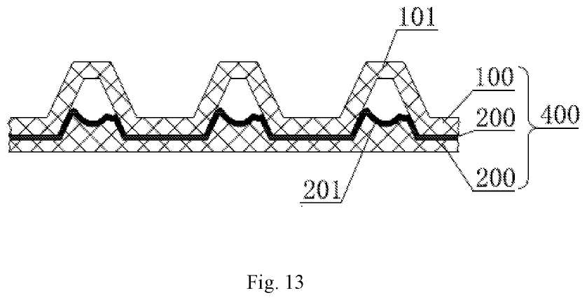

As illustrated in FIG. 13, the waterproof and drainage integrated board produced by a waterproof and drainage integrated board forming machine with the hot melt adhesive membrane is provided with a layer of hot melt adhesive membrane 300 between the drainage layer and the waterproof layer 200, which improves the peeling strength of the formed board and both life and reliability of the waterproof board.

The description above is an explanation of the present invention rather than restrictions. The present invention can be modified in any form, providing that the spirit of the present invention is not violated. For example, adjust the positions and angles of the four rollers or arrange the present invention horizontally as long as the waterproof layer and the drainage layer can be integrated into one piece.

1. A waterproof and drainage integrated board forming machine as described in claim 1, characterized in that a rack (1) is provided with a first concave roller (2), a convex roller (3), a second concave roller (4) and a mirror roller (5), the convex roller (3) rolls relative to the first concave roller (2) and the second concave roller (4), and the mirror roller (5) rolls relative to the second concave roller (4). A first concave roller (2) is made with a number of first concave cavities (21) on the roller surface, a second concave roller (4) is made with a number of second concave cavities (41) on the roller surface, a convex roller (3) is made with a number of convex grains (31) on the roller surface to match with the first concave cavities (21) and the second concave cavities (41) respectively; a mirror roller (5) is made with a smooth surface.

2. A waterproof and drainage integrated board forming machine as described in claim 1, characterized in that a convex roller (3) meets with a first concave roller (2) on the side of a first extruder head (24); a convex roller (3), a second concave roller (4) and a mirror roller (5) are arranged in order, and the second concave roller (4) meets with the mirror roller (5) on the side of a second extruder head (25).

3. A waterproof and drainage integrated board forming machine as described in claim 1, characterized in that the line of center between a convex roller (3) and a first concave roller (2) is orthogonal to the line of center among a convex roller (3), a second concave roller (4) and a mirror roller (5), and a convex roller (3), a second concave roller (4) and a mirror roller (5) are arranged vertically side by side.

4. A waterproof and drainage integrated board forming machine as described in claim 1, characterized in that the central axes of a first concave roller (2), a convex roller (2), a second concave roller (4) and mirror roller (5) are located in a horizontal plane; or the center axes of a second concave roller (4) and a mirror roller (5) is in a horizontal plane, and the angle β between the line of center between a first concave roller (2) and a convex roller (3) and that between a second concave roller (4) and a mirror roller (5) is greater than 90° and less than 180°.

5. A waterproof and drainage integrated board forming machine as described in claim 1, characterized in that the centering angle α of a wrapping arc (104) of a substrate (100) around a convex roller (3) is 180° or above, and the length of the wrapping arc (104) is nr or more.

6. A waterproof and drainage integrated board forming machine as described in claim 1, characterized in that a second extruder head (25) directs at the position where a second concave roller (4) meets with a mirror roller (5); or a second extruder head (25) moves a horizontal distance d away from the meeting position abovementioned and towards the mirror roller (5).

7. A waterproof and drainage integrated board forming machine as described in claim 1, characterized in that a heating device is provided in a second concave roller (4) or a mirror roller (5) at a temperature between 30° C. and 80° C.

8. A waterproof and drainage integrated board forming machine as described in claim 1, characterized in that a heating gun (27) is provided on the outside of a second concave roller (4) and heats the bottom surface of the substrate (100) at a temperature between 200° C. and 400° C.

9. A waterproof and drainage integrated board forming machine as described in claim 1, characterized in that a membrane winding roller (28) is provided on the outer side of the position where a second concave roller (4) meets with a mirror roller (5) to accommodate the hot melt adhesive membrane roll.

10. A waterproof and drainage integrated board forming machine as described in claim 1, characterized in that a heating plate (7) is equipped on the outside and keeps a certain distance from a second concave roller (4). The heating area partially covers the drainage layer winded during operation. The said heating plate is curved and is arranged outside of the second concave roller and near the top of the convex roller.

11. A waterproof and drainage integrated board forming machine as described in claim 1, characterized in that sliding blocks are equipped on the supports at both ends of a first concave roller (2), a convex roller (3) and a mirror roller (5). The rack (1) is correspondingly provided with slide rails, and the sliding blocks are arranged on the second slide rail in the sliding manner. A first concave roller (2), a convex roller (3) and a mirror roller (5) are driven to slide by a linear drive mechanism for adjustment of the gap between the two rollers. The opening diameters of first concave cavities (21) and second concave cavities (41) are matched and larger than the outer diameter of the convex grains (31). The radial spacing between the surface of convex grains and the inner surface of first concave cavities (21)/second concave cavities (41) matches the thickness of a substrate (100) or is larger. The gap between a mirror roller (5) and a second concave roller (4) is smaller than the sum of the thicknesses of a substrate (100) and a waterproof layer (200).

12. A waterproof and drainage integrated board forming machine as described in claim 1, characterized in that a first concave roller (2) is connected to the motor through a transmission mechanism; a first concave roller (2), a convex roller (3), a second concave roller (4) and a mirror roller (5) transmit the torque through gears; the rack (1) is provided with a guide roller (6) that is connected to the motor through a transmission mechanism.

13. A waterproof and drainage integrated board forming machine as described in claim 1, characterized in that some wheels (9) are equipped on both sides of the rack at the bottom oppositely, which are connected to the motor through a transmission mechanism and surrounded by wheel teeth (91). The rails (8) are arranged on the workshop floor correspondingly, and equipped with wheel teeth (81). The wheel teeth (91) of wheels (9) match the wheel teeth (81) of rails (8).

14. A waterproof and drainage integrated board forming process utilizing a waterproof and drainage integrated board forming machine as described in claim 1, characterized in that following steps are included:
I. A first extruder extrudes and forms a flat substrate (100);
II. A substrate (100) enters a first concave roller (2) and a convex roller (3), forming hollow bosses (101);
III. A waterproof layer is formed by a substrate (100) and bosses (101) and transferred from a convex roller (3) to a second concave roller (4);
IV. A second extruder extrudes and forms a flat waterproof layer (200) that enters with a drainage layer into a gap between a second concave roller (4) and a mirror roller (5); the waterproof layer (200) is fused with substrate (100) of the drainage layer on the bottom under a certain pressure, forming a waterproof and drainage integrated board.

15. A waterproof and drainage integrated board forming process as described in claim 14, characterized in that a substrate (100) is heated on the bottom before a waterproof layer (200) is fused with the bottom of the substrate (100).

16. A waterproof and drainage integrated board forming process utilizing a waterproof and drainage integrated board forming machine as described in claim 1, characterized in that a drainage layer consists of a substrate (100) and hollow bosses (101), a waterproof layer (200) is fused with a substrate (100) on the bottom and seals the open ends of bosses (100), and the drainage layer and the waterproof layer (200) are integrated during extrusion forming.

17. A waterproof and drainage integrated board as described in claim 16, characterized in that there is a “crater-like” press-in part (201) in bosses (101), which is high on the periphery and low in the center, and a fused flat layer (400) made from the drainage layer and the waterproof layer (200) among bosses (101).

18. A waterproof and drainage integrated board as described in claim 17, characterized in that the maximum thickness Tmax of a press-in part (201) is greater than the thickness t of a fused flat layer (400).

19. A waterproof and drainage integrated board as described in claim 17, characterized in that the minimum thickness Tmin of a press-in part (201) is greater than the thickness t₂ of a waterproof layer (200).

20. A waterproof and drainage integrated board as described in claim 17, characterized in that the average thickness T of a press-in part (201) is greater than the thickness t of a fused flat layer (400).

21. A waterproof and drainage integrated board as described in claim 16, characterized in that there is a hot melt adhesive layer bonding a drainage layer with a waterproof layer (200).
